(19) United States
(12) Patent Application Publication
(10) Pub. No.: US 2006/0165056 A1
(43) Pub. Date: Jul. 27, 2006

(54) Network terminal device, address management server, communication system, and network communication method using mac addresses to determine the ip target addresses

(75) Inventor: Norio Komaki, Fukuoka (JP)

Correspondence Address: STEVENS DAVIS MILLER & MOSHER, LLP, 1615 L STREET, NW, SUITE 850, WASHINGTON, DC, 20036, US

(73) Assignee: Matsushita Electric Industrial Co., Ltd., Osaka (JP)

(21) Appl. No.: 10/525,036

(22) PCT Filed: Aug. 20, 2003
(86) PCT No.: PCT/JP03/10520

§ 371 Date: Feb. 18, 2005

(30) Foreign Application Priority Data
Aug. 21, 2002 (JP) 2002-240128

(51) Int. Cl. H04L 12/66

(52) U.S. Cl. 370/352

(57) ABSTRACT

The present invention is intended to offer network terminal devices and an address management server which can communicate with a remote terminal without manually managing the IP address of the remote terminal. A network communication method therefor is also offered. The MAC address of a local terminal, the MAC address of the remote terminal, and the IP address of the address management server are stored in terminal devices. These terminal devices are connected with a network, and an IP address is gained. An inquiry of an IP address corresponding to the MAC address of the remote terminal is made to the address management server. When a response of the IP address of the remote terminal is made from the address management server, an access is made to this IP address.

### TECHNICAL FIELD

The present invention relates to a network terminal device that dispenses with IP address management on the terminal side and can make a communication with a remote terminal unconsciously of IP addresses during the communication, to an address management server capable of giving a notice of an IP address to this network terminal device, and to a network communication method therefor.

### BACKGROUND ART

Conventionally, network phone conversation systems that make voice communications utilizing the Internet, Intranets, or the like have been run. Users of the systems have connected their respective terminals with relay servers placed on the network. Two terminals are connected within such a relay server. Thus, voice signals are encoded, sent in IP packets, decoded, and delivered from a speaker. In this case, however, the communication quality depends on the relay server. Burden is placed on the processing of the relay server. Hence, the communication quality drops.

Accordingly, if two terminals are directly connected using IP addresses, stable telephone conversation not dependent on the traffic is made possible. However, with such a network system, it is necessary to enter the IP address of the communicating party for connection. This is quite troublesome. To make use of it, it has been necessary that the IP address be previously gained and the two terminals be connected. For this reason, a network phone conversation system capable of connecting terminals unconsciously of IP addresses has been proposed (JP-A-2001-313671). In this network phone conversation system, a management server that manages user's information including the IP addresses of terminals by means of IDs is provided. A terminal that wishes to connect is connected with this management server. The ID of the remote party is entered. The IP address of the remote party is requested. If a corresponding IP address is sent in, connection is made with the remote terminal based on this IP address. Thus, a voice communication is made.

In this network phone conversation system, however, it is necessary to enter and set up the ID of the remote party as well as the ID of the local terminal. ID management associated with them must be performed. The difference is only that IP address management is replaced by ID management. The burden on the user is still heavy.

Accordingly, a communication system for previously sending the IP address of the local terminal using a separate network has been proposed (JP-A-10-322391). In particular, prior to communication via a network, information including the IP address of the local terminal on the network is sent to the communicating party, or remote party, using one of plural channels such as ISDN as a separate network. The remote party sends a communication request through the communication network, using the IP address gained through the separate network. Thus, a communication through the network is carried out.

If the IP address of the remote terminal is not known, a notice of the information including the IP address is given, using the separate network. The remote party makes a communication request to this address. As a result, a communication via a network is made possible without performing address management. In order to make a connection via the management server of the aforementioned network phone conversation system, the power supply of the remote terminal must be ON; otherwise, the connection cannot be made. A state in which communication is impossible can be avoided because a communication request is made after a connectable state is established by a separate network. Also, it is not necessary to manage addresses. An end-to-end communication is possible. In these respects, the burden on the user is made relatively light.

In the background art network phone conversation system described so far, a management server for managing the IP addresses of terminals by IDs is provided. It has been necessary to manage the ID of the remote party ID, as well as the ID of the local terminal. The user is urged to perform ID management for phone conversation, thus placing great burden on him. In addition, to make a connection using a management server, the power supply of the remote terminal must be ON; otherwise, the connection cannot be made.

Moreover, in the communication system that previously sends an IP address using a separate network, the IP address is sent to the remote party using the separate network. The remote party sends a communication request through a network using this IP address. In this way, a communication is made. Therefore, a communication via a network is made possible if the IP address of the remote terminal is not known. Since a communication request is made after a connectable state is established by a separate network, an unconnectable state can be circumvented. Additionally, the burden on the user is relatively light in that no address management is necessary and that an end-to-end communication is possible.

However, an IP address is sent using a separate network and so a network having substantially plural channels such as ISDN is necessary. Usable cases are limited. In addition, although it can be said that the burden on the user is made lighter, a procedure consisting of activating the terminal by the user himself, sending an IP address by a separate network, and waiting for a communication request from the remote party must be performed. This is difficult for users unaccustomed to communications such as the aged and children. Accordingly, there is a demand for a network communication terminal that permits a user to make a communication with a remote terminal via a network entirely unconsciously of IP addresses.

### DICLOSURE OF INVENTION

Accordingly, it is an object of the present invention to provide a network terminal device which can communicate with a remote terminal without managing the IP address of the remote terminal and unconsciously of the IP address during communication.

It is another object of the invention to provide an address management server which makes it unnecessary for the terminal side to manage the IP address of a remote terminal and which can give a notice of the IP address of the remote terminal during communication.

It is a further object of the invention to provide a network communication method capable of communicating with a remote terminal without managing the IP address of the remote terminal and unconsciously of the IP address during communication.

To solve the foregoing problems, a network terminal device of the present invention is characterized as follows. When it detects that a user has made an input from an input unit for transmission, the MAC address of the remote terminal stored in a storage portion is sent to an address management server. Thus, an inquiry of the IP address of the remote terminal related to the MAC address is made. When the address management server makes a response of the IP address of the remote terminal, an access to the IP address is made.

Consequently, it is possible to communicate with the remote terminal without managing the IP address of the remote terminal and unconsciously of the IP address during communication.

An address management server of the invention is characterized in that it has: a storage portion in which a conversion table is stored, the table interrelating the MAC address of a terminal device and the IP address of the terminal device; and a control unit which, when there is a notice of the MAC address from the terminal device, adds the MAC address to the conversion table together with a corresponding IP address and which, when an inquiry of an IP address is made using a MAC address, gives a notice of this IP address if this IP address is in the conversion table.

In consequence, it is not necessary for the terminal side to manage the IP address of the remote terminal. During communication, it is possible to give a notice of the IP address of the remote terminal.

The network communication method of the present invention is characterized as follows. The MAC address of a local terminal, the MAC address of a remote terminal, and the IP address of an address management server are stored in a terminal device. The terminal device is connected with a network, and the IP address is gained. An inquiry is made to the address management server about an IP address corresponding to the MAC address of the remote terminal. When the address management server makes a response of the IP address of the remote terminal, an access to the IP address is made.

As a result, it is possible to communicate with the remote terminal without managing the IP address of the remote terminal and unconsciously of the IP address during communication.

### BRIEF DESCRIPTION OF DRAWINGS

FIG. 1 is a structural view of the whole network of a network communication system in first embodiment of the present invention.

FIG. 2(a) is a block diagram of a network terminal device in first embodiment of the invention.

FIG. 2(b) is a diagram illustrating an address table for the network terminal device of FIG. 2(a).

FIG. 3(a) is a block diagram of an address management server in first embodiment of the invention.

FIG. 3(b) is a diagram illustrating a conversion table for the address management server in first embodiment of the invention.

FIG. 3(c) is a diagram illustrating a conversion table for a DNS server in first embodiment of the invention.

FIG. 4 is a flowchart for setting up communications by IP phones by a network communication method of the present first embodiment.

### BEST MODE FOR CARRYING OUT THE INVENTION

### First Embodiment

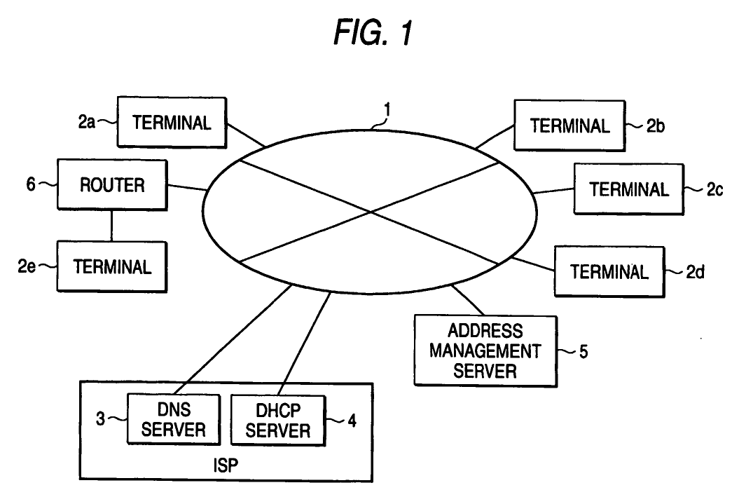

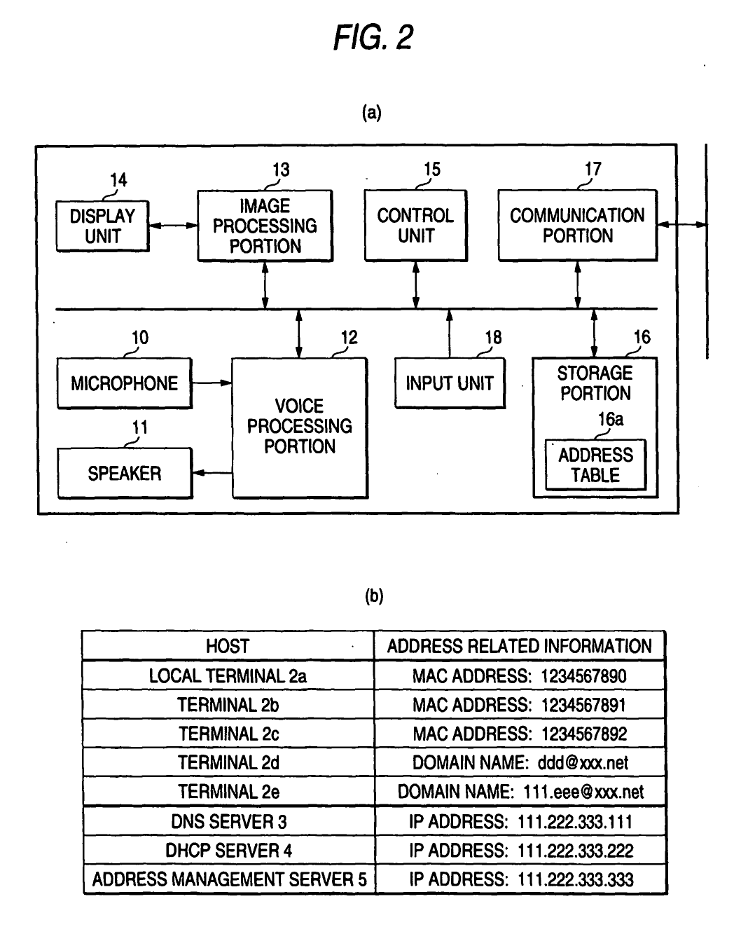

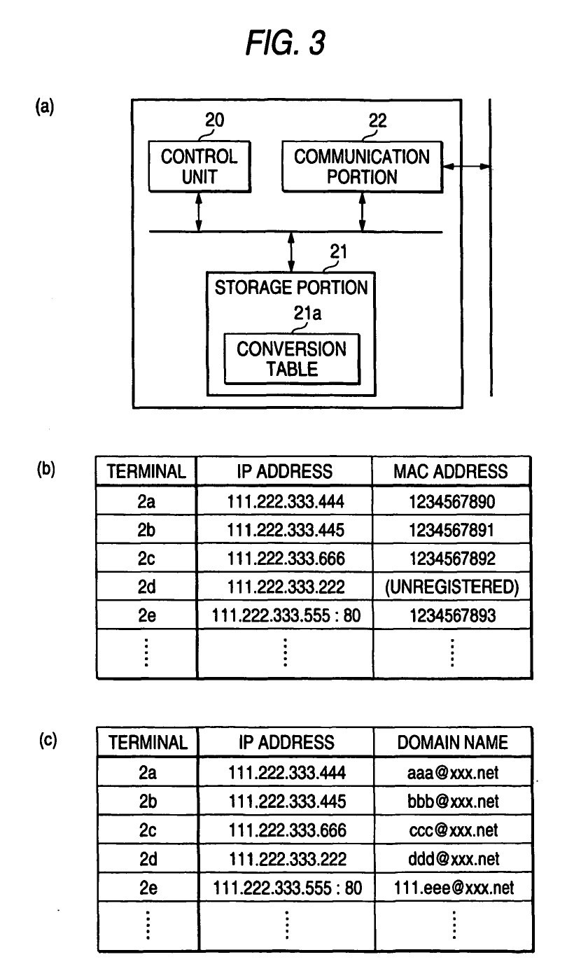

A network terminal device and an address management server in first embodiment of the present invention and a network communication method therefor are hereinafter described based on the drawings. FIG. 1 is a structural view of the whole network of a network communication system in first embodiment of the invention. FIG. 2(a) is a block diagram of the network terminal device in first embodiment of the invention. FIG. 2(b) is a diagram illustrating an address table for the network terminal device of (a). FIG. 3(a) is a block diagram of an address management server in first embodiment of the invention. FIG. 3(b) is a diagram illustrating a conversion table for the address management server in first embodiment of the invention. FIG. 3(c) is a diagram illustrating a conversion table for a DNS server in first embodiment of the invention.

In FIG. 1, numeral 1 is a network capable of making communications with protocols such as TCP/IP for an Intranet, the Internet, or the like. Numeral 2a, 2b, 2c, 2d, and 2e are network terminal devices (hereinafter referred to as the terminal devices) such as Internet phones (hereinafter referred to as IP phones) capable of making voice communications via the network 1. It is to be noted that the network terminal devices 2a, 2b, 2c, 2d, and 2e of the invention can make image communications, in addition to voice communications. The network terminal devices 2a and 2b are sold as one set like so to speak main and extension IP phones. During manufacture or sale, the MAC address of a local party and the MAC address of a remote party are initially loaded into memory and then the devices are sold. Numeral 3 is a DNS server. When the network terminal devices 2a, 2b, 2c, and 2d make inquiries of global IP addresses (hereinafter referred to as IP addresses) with the domain names of connection destinations instead of MAC addresses, the DNS server 3 can convert the domain names into IP addresses. Numeral 4 is a DHCP server for dynamically assigning IP addresses. Numeral 5 is an address management server that intercorrelates IP addresses and MAC addresses notified from the network terminal devices 2a, 2b, 2c, and 2e, registers them, and can convert MAC addresses into IP addresses when the network terminal devices 2a, 2b, 2c, and 2e make inquiries of IP addresses using the MAC addresses of the connection destinations. Numeral 6 is a router. In the present mode, the terminals 2a, 2b, 2c, and 2e are connected under control of an ISP. The DNS server 3 and DHCP server 4 manage the terminals 2a, 2b, 2c, and 2e.

Incidentally, the IP addresses of first embodiment are global IP addresses as mentioned so far. Where used within a LAN or in other similar case, IP addresses can be local IP addresses. Note that the network terminal device 2e under control of the router 6 in first embodiment does not make an inquiry to the DHCP server 4 about IP addresses. Although not illustrated, when a connection is made with the DNS server 3 via a public network from a telephone with a gateway, the telephone number is once converted into a given domain name for telephone as described later. The domain name is converted into a URI (uniform resource indicator) and finally into an IP address.

FIG. 2(a) shows the block structure of the network terminal devices 2a, 2b, 2c, 2d, and 2e. Numeral 10 is a microphone for entering voice as an IP phone. Numeral 11 is a speaker for producing a decoded voice signal as a voice as an IP phone. Numeral 12 is a voice processing circuit that performs an A/D conversion of the voice signal from the microphone 10 (and thus digitizes the signal), compresses the signal, produces encoded voice data, decompresses received voice data, performs a D/A conversion of it, and then produces the data as a voice signal.

Numeral 13 is an image processing portion that is provided because the network terminal devices 2a, 2b, 2c, 2d, and 2e of first embodiment also make image communications. The image processing portion decompresses received image data in the form of JPEG or MPEG, converts the data into an RGB signal, and produces an analog image signal. Numeral 14 is a display unit for displaying the image signal delivered from the image processing portion 13. The received image is displayed on a display such as an LCD by the operation of the display unit 14. A CCD camera (not shown) may be provided to accept an image signal. This is compressed by the image processing portion 13 and sent as image data in the form of JPEG or MPEG.

Numeral 15 is a control unit that is a central processing unit loaded with a control program. This control unit is a means for realizing a function of controlling the system. Numeral 16 is a storage portion that can store a control program and do temporal storing. Numeral 16a is an address table provided in the storage portion 16. Address information to which the network terminal devices 2a, 2b, 2c, 2d, and 2e make access is stored in the address table. Numeral 17 is a communication portion that connects with a network and can perform a communication management and provide a communication control of a data link layer. Numeral 18 is an input unit that makes an input by depression or the like of a ten key or a send button. The communication portion 17 manages communications according to protocol SIP or H.323 when voice communications are made and according to protocol HTTP or the like when image communications are made. Alternatively, voice data may be compressed in the form of ADPCM or the like, image data may be compressed in the form of JPEG or the like, and transmission may be made simply by carrying voice and image data on the data area of TCP/IP.

FIG. 2(b) shows an address table for the network terminal device 2a. Host and address information are interrelated. The MAC address of the local terminal is initialized to 1234567890. In the present first embodiment, also with respect to the network terminal device 2b that corresponds to the extension phone of a set of IP phones (main and extension phones) manufactured and sold as a set, the MAC address is initialized to 1234567891 and stored in memory. The network terminal device 2b is similar. The address information on the network terminal device 2c is MAC address “1234567892”. The address information on the network terminal device 2e is MAC address “1234567893”. These were afterward set by user's inputs after connection with the network 1. However, where all the network terminal devices 2a, 2b, 2c, and 2e are sold as one set, all the MAC addresses of the network terminal devices 2a, 2b, 2c, and 2e excluding their respective local terminals (i.e., remote terminals) can be initially stored in memory. Each terminal device is provided with plural send buttons for remote terminals, respectively. By selecting one send button, an incoming call to the selected terminal is allowed. After response by this terminal, a telephone conversation or the like is permitted. On an incoming call, a button corresponding to the sending terminal emits light.

Address information on the network terminal device 2d is not a MAC address but domain name “ddd@xxx.net” that is stored in memory. This was set afterward by an input of the user after connection with the network 1. The IP address of the DNS server 3 (111.222.333.111), the IP address of the DHCP server 4 (111.222.333.222), and the IP address of the address management server 5 (111.222.333.333) are stored in the address table 16a. The IP address of the address management server 5 was already initialized on sale, in the same way as MAC addresses. The network terminal devices 2a, 2b, 2c, and 2e can make inquires to the address management server 5 about the IP address, using the MAC address of the remote terminal. The terminal devices can also make an inquiry to the DNS server 3 about the IP address, using the domain name of the remote terminal. In either case, if the IP address is gained, an IP phone communication can be made between them, using this address. The network terminal devices 2a, 2b, 2c, and 2e have DHCP client functions. When connected with a network, they broad cast network setting requests including allotment of IP addresses, whereby network setting information including IP addresses is received from the DHCP server 4. At this time, the IP address of the DHCP server 4 is also received and stored in the address table 16a. Subsequently, the IP address stored in the address table 16a will be used when an access is made to the DHCP server 4. The DNS server 4 is stored in the address table 16a by making an input from the input unit 18 by the user. The IP address of the DNS server 3 is normally notified from the ISP, or provider, in a written document or the like, when a connection is made with the ISP. It is also possible to receive it as network setting information from the DHCP server 4.

Then, the address management server and DNS server are described based on FIG. 3,(a), (b), and (c). FIG. 3(a) shows the block structure of the address management server 5. Numeral 20 is a control unit that is a central processing unit loaded with a control program. This control unit is a means for realizing a function of controlling the system. Numeral 21 is a storage portion which can store a control program and do temporal storing. Numeral 21a is a conversion table provided in the storage portion 21. The table interrelates the address information (MAC addresses) on the network terminal devices 2a, 2b, 2c, 2d, 2e and IP addresses. Numeral 22 is a communication portion that connects with a network and can perform a communication management and provide control of a data link layer. The block structure (not shown) of the DNS server 3 is fundamentally identical with the block structure of the aforementioned address management server 5 except for the contents of address information (described later) and its description is omitted.

In the conversion table 21a of the address management server 5, IP address and MAC address are interrelated for each terminal as shown in FIG. 3(b). That is, the network terminal devices 2a, 2b, 2c, 2d, and router 6 are clients of the DHCP server 4. Within the range of IP addresses of 111.222.333.111 to 111.222.333.777, IP addresses are dynamically assigned by the DHCP server 4. The IP address 111.222.333.444 of the network terminal device 2a, the IP address 111.222.333.445 of the network terminal device 2b, the IP address 111.222.333.666 of the network terminal device 2c, the IP address 111.222.333.222 of the network terminal device 2d, and the IP address 111.222.333.555:80 of the network terminal device 2e are IP addresses dynamically assigned in this way at some instant of time.

The IP addresses are related to the MAC address 1234567890 of the network terminal device 2a, MAC address 1234567891 of the network terminal device 2b, and MAC address 1234567892 of the network terminal device 2c, respectively. Note that the MAC address of the network terminal device 2d is not registered.

Then, the conversion table for the DNS server 3 interrelates IP address and domain name for each terminal as shown in FIG. 3 (c). The network terminal device 2a is related to domain name “aaa@xxx.net”. The network terminal device 2b is related to domain name “bbb@xxx.net”. The network terminal device 2c is related to domain name “ccc@xxx.net”. The network terminal device 2d is related to domain name “ddd@xxx.net”. The network terminal device 2e is related to domain name “111.eee@xxx.net”.

Incidentally, ENUM (telephone number mapping) is available as a protocol for connecting a telephone number with various applications on the Internet using a DNS. In the case of this ENUM, the telephone number is first converted into a domain name. This is converted into a URI by the DNS. The URI is then changed into an IP address. In a system for implementing this ENUM function, the domain name is converted into a URI and then from the URI to an IP address by the ENUM function server. Therefore, instead of the DNS server 3, an ENUM server including this DNS function may be positioned.

At this time, the conversion table for the ENUM server interrelates IP address, URI, and domain name for each terminal. Although the domain name is different from the case where a telephone number is converted, the network terminal device 2a is related to an IP address, a URI “http://aaa.xxx.net”, and a domain name “aaa@xxx.net”, for example. The network terminal device 2b is related to an IP address, a URI “http://bbb.xxx.net”, and a domain name “bbb@xxx.net”. The network terminal device 2c is related to an IP address, a URI for voice communication “sip:ccc@xxx.net”, and a domain name “ccc@xxx.net”. The network terminal device 2d is related to an IP address, a URI for voice communication “sip:ddd@xxx.net”, and a domain name “ddd@xxx.net”. The network terminal device 2e is related to an IP address, a URI for voice communication “sip:111.eee@xxx.net”, and a domain name “111.eee@xxx.net”.

When IP addresses are dynamically assigned to the network terminal devices 2a, 2b, 2c, and 2d by the DHCP server 4, the devices update the IP addresses of the address management server 5 and of the DNS server 3. The DNS server 3 can receive an IP address from the DHCP server 4. A DDNS server (not shown) is mounted in a corresponding manner to the DNS server 3. An IP address dynamically assigned by the DHCP server 4 is related to a domain name, and the conversion table is updated.

For example, when the network terminal device 2a makes an inquiry to the address management server 5 about the IP address of the network terminal device 2b using a MAC address, the address management server 5 gives a notice of the IP address to the network terminal device 2a according to the conversion table 21a. In the case of the network terminal device 2d that is not a client of the address management server 5, an inquiry of the IP address is made using a domain name. The DNS server 3 gives a notice of a corresponding IP address from the conversion table 21a.

How a setup using MAC addresses is performed for the network terminal devices 2a and 2b when connections are made is now described, the terminal devices being main and extension devices. First, the network terminal device 2a is connected with the network 1. Triggered by this physical connection, a program which is set up on connection and stored in the storage portion 16 by initialization is loaded into the central processing unit, and then the control unit 15 starts the setting function. The control unit 15 broadcasts a network setting request including allotment of IP addresses to the DHCP server 4 and thus makes a request. The control unit gains the network setting information including the IP address of the local terminal (i.e., 111.222.333.444) from the DHCP server 4 and stores it in the address table 16a.

Then, if the send button of the network terminal device 2a is depressed, the network terminal device 2a reads the MAC addresses of the local terminal and of the network terminal device 2b and the IP address of the address management server 5 from the address table 16a. The MAC address information is set into the data area, and an IP packet having a given header is created. At this time, the IP address of the address management server 5 is set into the destination IP address of the header. The gained IP address “1111.222.333.4441” is set into the source IP address. A given number is set into the port number. An IP packet created in this way is sent to the network 1.

This IP packet sent to the network 1 is received by the address management server 5. The address management server 5 takes out the MAC address and IP address of the network terminal device 2a and the MAC address of the network terminal device 2b that is the communicating party, from the data area. A check is made as to whether there is a MAC address for the network terminal device 2a. Where the MAC address of the network terminal device 2a is not registered or where the address is registered but the received IP address is different, the MAC address and IP address of the network terminal device 2a are interrelated and written into the conversion table 21a. Then, a check is made as to whether the MAC address of the network terminal device 2b is stored in the conversion table 21a.

Where the MAC address of the network terminal device 2b is not stored in the conversion table 21a, it is impossible to give a notice of the IP address of the network terminal device 2b. Therefore, the address management server 5 sends a response message indicating arrival of a call to the network terminal device 2a. Accordingly, the network terminal device 2a waits under this condition until the MAC address of the network terminal device 2b is stored in the conversion table 21a. Where it is impossible to give a notice of the IP address of the network terminal device 2b in this way, the address management server 5 sends display information that the network terminal device 2b is not registered with the address management server 5 to the network terminal device 2a. If the display information is displayed by the network terminal device 2a, then the user of the network terminal device 2a can recognize the circumstances e.g., the network terminal device 2b is not connected with the network.

If the network terminal device 2b is connected with the network 1 at an instant of time later than the time when a setup is performed for the network terminal device 2a, the control unit 15 that is triggered by the connection reads the control program by initialization and starts the setting function of the network terminal device 2b. The control unit 15 broadcasts and thus makes a network setting request including allotment of IP addresses to the DHCP server 4. The network setting information including IP address “111.222.333.445” is gained from the DHCP server 4 and stored in the address table.

Subsequently, in a case when the send button of the network terminal device 2b is depressed, the MAC addresses of the local terminal and of the network terminal device 2a and the IP address of the address management server 5 are read from the address table. The MAC address information is set into the data area, and an IP packet is created. At this time, the IP address of the address management server 5 is set into the destination IP address of the header. The gained IP address “111.222.333.445” and a given port number are set into the source IP address. This IP packet is sent to the network 1.

When the packet is received from the network 1, the address management server 5 takes out the MAC address and IP address of the network terminal device 2b and the MAC address of the network terminal device 2a that is the communicating party. The MAC address of the network terminal device 2b and the IP address are interrelated and written into the conversion table 21a. Then, a check is made as to whether the MAC address of the network terminal device 2a is stored in the conversion table 21a.

At this time, the MAC address of the network terminal device 2a is already present in the conversion table 21a and so the address management server 5 sets the IP address of the network terminal device 2a into the response message and gives a notice to the network terminal device 2b. When this response message is received, the network terminal device 2b sets the IP address “111.222.333.444” of the network terminal device 2a into the destination IP address and sets the IP address “111.222.333.445” of the local terminal into the source IP address. The network terminal device 2b makes an access to the network terminal device 2a with protocol SIP, H.323, or the like. Consequently, the network terminal device 2b can call the network terminal device 2a. The network terminal device 2a responds to this call. Thus, a telephone conversion can be made between the network terminal device 2a and the network terminal device 2b. That is, the network terminal device 2a that has received an IP packet for calling from the network terminal device 2b takes out digital data of the calling signal from the storage portion 16 of the local terminal. A calling sound is produced from the speaker 11 via the voice processing circuit 12. The user of the network terminal device 2a listening to the calling sound depresses a response button (that may be in common with the send button). Thus, the voice path with the network terminal device 2b is connected. Consequently, a voice communication is made possible.

Under this condition, (i.e., when the MAC address and IP address of the network terminal device 2b are registered in the conversion table 21a), after communication between the network terminal devices 2a and 2b ends, an inquiry is made to the address management server 5 about an IP address corresponding to the MAC address of the network terminal device 2b simply by depressing the send button of the network terminal device 2a. The IP address of the network terminal device 2b is gained. Thus, the IP address of the network terminal device 2b is set into the destination IP address. The IP address of the local terminal is set into the source IP address. It is possible to make an access to the network terminal device 2b with protocol SIP or H.323.

In some cases, the IP address of the local terminal device varies dynamically. Therefore, the network terminal devices 2a and 2b are preferably reconnected with the network 1, or when the power supply is changed from OFF to ON or in other similar case, a request of IP address allotment is made to the DHCP server. Thus, whenever an IP address is gained, the MAC address and IP address of the local terminal are sent to the address management server 5 to vary the conversion table 21a. In this way, the network terminal devices 2a and 2b can be connected with the network terminal device 2a that is the communicating party making a pair, simply by depressing the send button. Consequently, a peer-to-peer communication on the network 1 can be made possible quite easily.

Furthermore, where the network terminal device is connected under control of the router, if the IP address of the router dynamically varies, the network terminal device cannot recognize the variation of the IP address. In such a case, it is desirable that the network terminal device send the MAC address and IP address of the local terminal to the address management server 5 at regular intervals of time to vary the conversion table 21a.

The network terminal device 2a can increase the number of terminals that can be communicated other than the network terminal device 2b that makes a pair, by making an input from the input unit 18 to enter IP addresses and domain names for terminals other than the network terminal device 2b (e.g., the network terminal devices 2d and 2e in FIG. 2(b)) or to enter a MAC address for the network terminal device 2c in FIG. 2(b), for example. The choice of the communicating party is made as follows. The control unit 15 reads out the address table 16a. The user selects any one of the terminal devices displayed on the display unit by the input unit. Then, the send button is depressed. In this manner, the communication with the selected terminal device is made possible.

Where the address management server 5 of first embodiment is used and a connection is made using the MAC addresses of the network terminal devices 2a, 2b, 2c, and 2e in this way, a setup can be performed without any special operation simply by connecting the network terminal devices 2a, 2b, 2c, and 2e such as main and extension phones or group phones with a network physically. The IP phones can be used immediately. Where a large number of terminal devices are installed in a LAN as a set, a switch may be mounted to select whether they are used on the same network such that IP addresses can be gained using a RARP protocol. Where the switch is so switched that the RARP protocol is used, it is not necessary to mount the address management server 5 as long as on the same network. Furthermore, when a connection is made from the network terminal device 2a to the other network terminal device 2c, for example, if the power supply of the network terminal device 2c is not ON, a message storage function may be imparted to the address management server 5 so that playback can be performed.

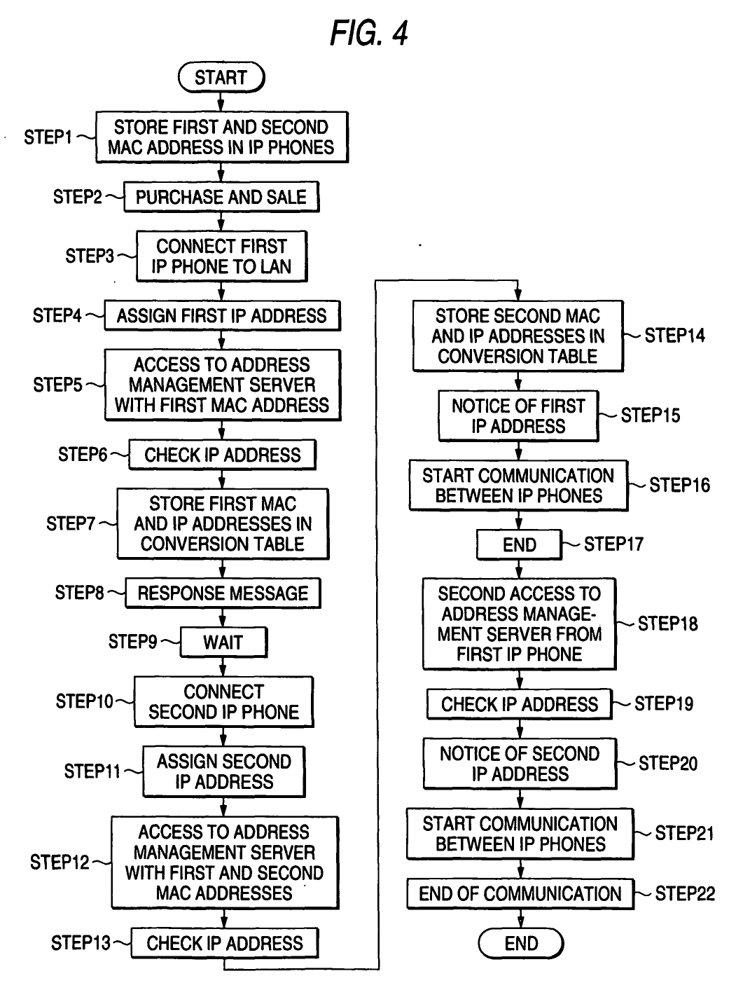

A procedure of making a communication by the network communication method of the present first embodiment is next described. FIG. 4 is a flowchart for setting up the communication using IP phones by the network communication method of the present first embodiment.

First, when IP phones which are used as one set are manufactured and sold, the MAC address of one (its own) phone (hereinafter may be referred to as the first MAC address) and the MAC address of the communicating party (hereinafter may be referred to as the second MAC address) are stored in each IP phone (step 1). Under the condition where the MAC addresses are stored, the user purchases them (step 2). The user of the IP phones physically connects one (hereinafter may be referred to as the first IP phone) of the IP phones forming a set to a LAN (step 3). After the connection, if the user pushes the send button of the first IP phone, the DHCP server assigns an IP address to this IP phone (step 4). The IP address of the address management server is read out. The first MAC address and the second MAC address are set into the data area, and an access is made to the address management server (step 5).

The address management server performs a check as to whether the second IP address corresponding to the second MAC address sent in is stored or not (step 6). Since the first IP phone of the set of IP phones was first connected, the second IP address is not stored. Therefore, the address management server stores the MAC address of the first IP phone and its IP address in the conversion table (step 7), and sends a response message in which the second IP address is not set to this first IP phone (step 8). Then, the server waits until the second IP phone is connected (step 9).

After the step 9, if another user connects the second IP phone physically (step 10), and if he depresses the send button, an IP address is assigned to this second IP phone by the DHCP server (step 11). The IP address of the address management server is read out. The second MAC address and the first MAC address are set into the data area, and an access is made to the address management server (step 12).

The address management server performs a check as to whether the first IP address corresponding to the first MAC address sent in is stored or not (step 13). Since the first IP phone has been already connected and the first IP address is stored, the address management server stores the MAC address of the second IP phone and its IP address in the conversion table (step 14), and gives a notice of the already stored IP address of the first IP phone to the second IP phone (step 15).

The second IP phone that has received the already stored IP address of the first IP phone by this response message makes an access to the first IP phone at this IP address and starts a peer-to-peer communication (step 16).

After the end of the communication (step 17), the previously connected first IP phone makes a second access to the address management server (step 18). The address management server performs a check as to whether an IP address corresponding to the MAC address sent in is stored or not (step 19). At this time, both IP phones are already connected, and their IP addresses are already stored. Therefore, a notice of the already stored IP address of the second IP phone is given to this first IP phone (step 20). The first IP phone which was previously connected and has received the IP address of this second IP phone makes an access to the second IP phone at this IP address and starts a peer-to-peer communication (step 21). When this communication ends (step 22), a sequence of setting procedures ends.

Since the IP addresses of the network terminal devices 2a and 2b may vary dynamically, whenever the network terminal devices 2a and 2b subsequently make a request for IP address allotment to the DHCP server 4 and receive allotment of IP addresses, the information is preferably registered with the address management server 5 to update it. Furthermore, after connection with the network, registration with the address management server 5 and inquiry may be separately performed. That is, the send button is depressed by initialization. The MAC address and IP address of the local terminal are registered with the address management server 5, thus completing the setup. When the send button is then depressed, an inquiry is made to the address management server 5 as to an IP address corresponding to the MAC address of the remote terminal device.

In this way, according to the network communication method of the present first embodiment, the MAC address of itself is previously stored in one set of IP phones. In addition, the MAC address of the other is stored. A peer-to-peer communication between the IP phones of one set can be made quite easily simply by connecting with a network without the need for the user to perform any annoying setup at all. Even an aged person who is not accustomed to settings of communications can easily make a connection.

### INDUSTRIAL APPLICABILITY

According to the network terminal device of the present invention, the remote terminal device can be identified using MAC addresses because MAC addresses are intrinsic to all of their respective electronic devices. Where MAC and IP addresses are interrelated in an address management server, the IP address of the remote terminal device can be gained by making an inquiry of this IP address. A peer-to-peer communication with the remote terminal device is made possible. The terminal device does not need to manage the IP address of the remote terminal. When a communication is performed, the communication can be made with the remote terminal unconsciously of the IP address.

If the MAC addresses of plural terminal devices making one set are stored in a storage portion, the remote terminal device can be identified using MAC addresses. Where there are plural remote terminals, one send button is selected from plural send buttons. Thus, a remote terminal can be selected. This facilitates operations for communication. Furthermore, an image processing portion for encoding and decoding image signal is provided. Therefore, images can be sent and received.

Furthermore, when connection is made with a network, IP addresses can be automatically obtained. Communication can be performed without relying on troublesome operations. If IP addresses are modified dynamically by a DHCP server, the IP address of the address management server can be updated. An access from the remote terminal device can be made.

According to the address management server and network management method of the present invention, the IP address of the remote terminal device can be found by referring to a conversion table in which MAC addresses and IP addresses are interrelated. A peer-to-peer communication with the remote terminal device can be performed. It is not necessary to manage the IP address of the remote terminal. During communication, it is easy to give a notice of the IP address of the remote terminal. It is possible to communicate with the remote terminal unconsciously of the IP address. If IP addresses are dynamically modified by the DHCP server, the IP address of the address management server can be updated. An access from the remote terminal device can be made.

1. A network terminal device comprising:
a communication portion connecting with a network to perform a communication;
a storage portion for storing a MAC address of a local terminal and a MAC address of a remote terminal and storing an address of an address management server;
a voice processing portion for encoding and decoding a voice signal when a voice communication is performed; and
an input unit operated by a user to start a communication;
wherein when it is detected that an input is made from the input unit by the user for transmission, the MAC address of the remote terminal stored in the storage portion is sent to the address management server to thereby make an inquiry of an IP address of the remote terminal related to said MAC address and wherein when a response of the IP address of the remote terminal is made from the address management server, an access is made to this IP address.

2. The network terminal device set forth in claim 1, wherein
the remote terminal is a plurality of network terminal devices making one set.

3. The network terminal device set forth in claim 1, wherein the network terminal device is an IP phone.

4. The network terminal device set forth in claim 2, wherein plural send buttons are provided for each remote terminal, and wherein when a communication is started, one send button is selected from the plural send buttons and an input is made for transmission.

5. The network terminal device set forth in any one of claims 1 to 4, comprising a display unit and an image processing portion for encoding and decoding an image signal when image communication is performed.

6. The network terminal device set forth in claims 1, wherein when said control unit detects that a user has made an input for transmission from said input unit, the control unit sends MAC address and IP address of the local terminal for registration with said address management server, in addition to the MAC address of the remote terminal.

7. The network terminal device set forth in claim 6, wherein when connection is made with said network, said control unit broadcasts a request for allotment of an IP address, receives allotment of an IP address from a DHCP server, and informs said address management server that the IP address of the local terminal has been updated by the DHCP server.

8. An address management server comprising:
a communication portion connecting with a network to perform a communication;
a storage portion stored with a conversion table in which MAC addresses of terminal devices and IP addresses of the terminal devices are interrelated; and
a control unit which, when a notice of a MAC address is given from a terminal device, adds the MAC address to the conversion table together with a corresponding IP address and which, when an inquiry of an IP address is made using a MAC address, gives a notice of the IP address, if the IP address is present in the conversion table.

9. The address management server set forth in claim 8, wherein when a notice that an IP address has been updated by a DHCP server is given from a terminal device, the IP address in the conversion table is updated.

10. A network communication method comprising the steps of:
storing a MAC address of a local terminal, a MAC address of a remote terminal, and an IP address of an address management server in a terminal device;
connecting the terminal device with a network and gaining an IP address;
making an inquiry to the address management server as to an IP address corresponding to the MAC address of the remote terminal; and
making an access to the IP address of the remote terminal when the address management server makes a response of this IP address.

11. A communication system comprising:
a plurality of network terminal devices each having a communication portion connecting with a network to perform a communication, a storage portion for storing a MAC address of a local terminal and a MAC address of a remote terminal and storing an address of an address management server, and an input unit operated by a user to start a communication; and
the address management server having a communication portion connecting with a network to perform a communication, a storage portion stored with a conversion cable in which the MAC addresses of the network terminal devices and IP addresses of the network terminal devices are interrelated, and a control unit which, when a notice of a MAC address is given from a network terminal device, adds the MAC address to the conversion table together with a corresponding IP address and which, when an inquiry of an IP address is made using a MAC address, gives a notice of the IP address, if it is present in the conversion table;
wherein a notice of the IP address of the remote terminal is given to the plurality of network terminal devices from the address management server and then the network terminal devices make an access to this IP address and perform direct communication between the network terminal devices.

12. The communication system set forth in claim 11, further including a DNS server having a communication portion connected with a network to perform a communication, a storage portion stored with a conversion table in which domain names of the network terminal devices and IP addresses of the network terminal devices are interrelated, and a control unit which, when an inquiry of an IP address is made using a domain name from a network terminal device, gives a notice of this IP address if it is present in the conversion table, and wherein a notice of the IP address of the remote terminal is given to the plurality of network terminal devices from the DNS server and then the network terminal devices make an access to this IP address and perform direct communication between the network terminal devices.

13. The communication system set forth in claim 12, wherein said DNS server is an ENUM server.

14. The communication system set forth in claim 12, further including a DHCP server for dynamically assigning the IP addresses of said plurality of network terminal devices, and wherein when the IP addresses are dynamically assigned by the DHCP server, the network terminal devices update an IP address of the address management server or of the DNS server.

15. The network terminal device set forth in claim 2, wherein when said control unit detects that a user has made an input for transmission from said input unit, the control unit sends MAC address and IP address of the local terminal for registration with said address management server, in addition to the MAC address of the remote terminal.

16. The network terminal device set forth in claim 3, wherein when said control unit detects that a user has made an input for transmission from said input unit, the control unit sends MAC address and IP address of the local terminal for registration with said address management server, in addition to the MAC address of the remote terminal.

17. The network terminal device set forth in claim 4, wherein when said control unit detects that a user has made an input for transmission from said input unit, the control unit sends MAC address and IP address of the local terminal for registration with said address management server, in addition to the MAC address of the remote terminal.

18. The network terminal device set forth in claim 5, wherein when said control unit detects that a user has made an input for transmission from said input unit, the control unit sends MAC address and IP address of the local terminal for registration with said address management server, in addition to the MAC address of the remote terminal.
